(19) United States
(12) Patent Application Publication
(10) Pub. No.: US 2013/0269245 A1
(43) Pub. Date: Oct. 17, 2013

(54) COMPOSITE FLORAL SPHERE

(71) Applicant: Mario Humberto Lozano Cavazos, Sector Zafiro (MX)

(72) Inventor: Mario Humberto Lozano Cavazos, Sector Zafiro (MX)

(21) Appl. No.: 13/446,626

(22) Filed: Apr. 13, 2012

(51) Int. Cl. A01G 5/06

(52) U.S. Cl. 47/41.12; 47/41.01

(57) ABSTRACT

A composite floral sphere to receive and maintain fresh cut vegetation in a floral arrangement is presented. The composite floral sphere includes a core of a first hydrophobic material, such as urethane foam. That core is fully encased by a shell bonded to the core, the shell being made of a hydrophilic or wettable material such as a wettable phenolic foam. A support rod including an enlarged head at one end and a receiving hook or ring at the other passes diametrically through the sphere. Fresh cut flowers or other vegetation have their stems cut to a length which is less than the thickness or depth of the shell of wettable material, the cut stems being inserted into the shell and receiving moisture therefrom when the shell is hydrated.

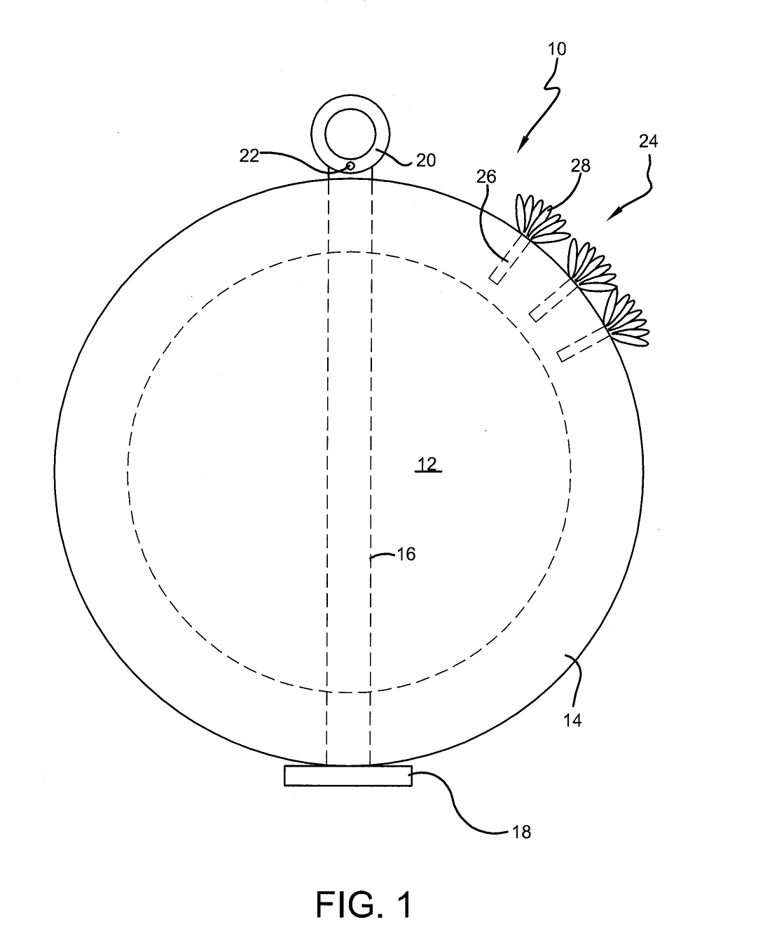

### TECHNICAL FIELD

The invention herein resides in the art of floral foams as are commonly used to provide a base for floral arrangements of fresh-cut vegetation. More particularly, the invention herein relates to a sphere of floral foam construction, allowing the presentation of a ball-like floral arrangement. Specifically, the invention relates to a floral sphere of an integrated core bonded to a surrounding shell, the core and shell being of different foams.

### BACKGROUND ART

It is now commonplace to employ hydrophilic foam structures to provide a base for floral arrangements of fresh-cut vegetation. The hydrophilic foam of the base receives water, often to a point of saturation, the water providing means to maintain the vitality of the fresh-cut vegetation, the stems of which are inserted into the foam base. In the past, the foam base has typically been of a uniform or homogeneous nature, consisting of a single type of hydrophilic or wettable foam. Typically, the foam base has comprised a rather low profile structure, typically adapted to be placed upon a tabletop or other flat surface, with the flowers and vegetation extending outwardly therefrom.

There is a desire in the art for floral bases of a spherical nature, allowing the development of floral spheres, which may be suspended from above or supported from below, while exhibiting flowers and/or other vegetation about the entire exterior spherical surface thereof. However, attempts to form spheres of a hydrophilic foam have generally been unsuccessful in that the amount of water absorbed by the sphere renders the sphere inordinately heavy and unsuitable for suspension or support. Moreover, the basic sphere itself is often inordinently heavy, even when dry, because of the nature and the density of the hydrophilic foam itself. Since spheres are necessarily of a larger volume than corresponding low profile floral bases, shipping and handling costs become unnecessarily aggravated as a result.

There is a need in the art for a base for a floral sphere that is inherently lightweight, prior to and during use, and which has the structural integrity to be suspended from above or supported from below, and which provides a means for keeping fresh cut flowers and vegetation fresh-looking over an extended period of time.

### DISCLOSURE OF INVENTION

In light of the foregoing, it is a first aspect of the invention of various embodiments of the invention to provide a composite floral sphere that is constructed of lightweight foam.

Another aspect of various embodiments of the invention is the provision of a floral sphere that is adapted for maintaining water in a region thereof sufficient to maintain the vitality of fresh cut flowers and vegetation received thereby.

Still a further aspect of various embodiments of the invention is the provision of a floral sphere that is constructed of lightweight foam material, and which is configured in such a manner as to maintain water in an outer region of the sphere while remaining dry in the interior portion.

Still another aspect of various embodiments of the invention is the provision of a composite floral sphere consisting of both hydrophilic and hydrophobic foam, the former providing a water source for the cut flowers and vegetation of the floral arrangement, and the latter providing structural integrity.

Yet an additional aspect of the invention is the provision of a composite floral sphere that may be readily devised using state of the art foam technology.

The foregoing and other aspect of the invention that will become apparent as the detailed description proceeds are achieved by a composite floral base for receiving and maintaining fresh cut vegetation in a floral arrangement, comprising: a core of a first hydrophobic material; and a shell of a second hydrophilic material encasing said core.

Other aspects of the invention that will become apparent herein are achieved by a composite floral sphere for receiving and maintaining fresh cut vegetation in a floral arrangement, comprising: a core of a hydrophobic foam; and a shell of a hydrophilic foam bonded to and encasing said core.

Still further aspects of various embodiments of the invention are achieved by a spherical floral arrangement, comprising: an inner core of hydrophobic foam; an outer shell of hydrophilic foam bonded to said inner core; and a plurality of flowers having cut stems received by said outer shell, heads of said flowers extending about an outer surface of said shell.

### DESCRIPTION OF DRAWINGS

For a complete understanding of the various aspects and features of embodiments of the invention, reference should be made to the following detailed description and accompanying drawing wherein an illustrative view of the composite floral sphere of the invention is shown, with interior elements presented in phantom.

### BEST MODE AND PREFERRED EMBODIMENT

Referring now to the drawing, it can be seen that a floral foam sphere made in accordance with the invention is designated generally by the numeral 10. The floral foam sphere 10 includes an inner spherical core 12 surrounded by an outer spherical shell 14. The inner spherical core 12 is typically made of a non-absorbent or hydrophobic material, while the outer spherical shell 14 is, in contradistinction, made of hydrophilic or wettable material. According to a preferred embodiment of the invention, the inner spherical core 12 may be made of any of various materials, such as a urethane foam. Such a core is both solid and strong in nature, provides support for the outer spherical shell 14 that may be bonded thereto, and while further maintaining and ensuring the integrity of the sphere when suspended from above or supported from below. Urethane foam is most preferred because of its hydrophobic nature, light weight, and structural integrity that resists crumbling and separation.

The outer spherical shell 14 is most preferably of a hydrophilic material, which can be of any of various sorts, but is most preferably a wettable foam such as a phenolic based wettable foam. It has been found that a phenolic based wettable foam can bond readily to and consistently about a core of urethane foam.

According to preferred embodiments of the invention, the outer spherical shell 14 will typically have a thickness of 1-3 inches, and preferably on the order of 2 inches. The shell 14 is preferably of uniform thickness about the entire sphere. Such a shell has been found to be of sufficient thickness or depth to receive the stems of cut flowers and vegetation to maintain them within the wettable foam during use.

The inner spherical core 12 may be of any of various sizes, but is preferably on the order of 10-14 inches in diameter, and preferably 12 inches in diameter. The resultant sphere 10 of such a preferred embodiment would thus have an overall diameter of 16 inches, although those skilled in the art will readily appreciated that the dimensions may vary. Those skilled in the art will also appreciate that the outer spherical shell 14 may be cast or over molded onto the core 12 in such a manner as to bond the two together.

With continued reference to the drawing, it can be seen that a hanging or support rod 16 extends diametrically through the sphere 10, passing through the core 12 and surrounding outer spherical shell 14. The hanging rod 16 includes an enlarged head or flat washer 18 at a lower end thereof, and a hook or support ring 20 secured to the rod 16 as by a pin 22 at the opposite end thereof. The integrity of the bonded combination of the inner core 12 of urethane foam and the outer spherical shell 14 of phenolic based wettable foam provides sufficient integrity that support as by the washer or head 18 is sufficient to suspend the floral foam sphere 10 from the hook or ring 20.

As further shown in the drawing, a multitude of fresh cut flowers or other vegetation 24 is received by the outer surface of the spherical shell 14. The stems of the flowers or vegetation 24 are cut to a length less than the thickness or depth of the wettable foam shell 14, such that the stems may be inserted into the wettable foam shell 14 and be nourished by the water entrained therein. With the shell 14 having a thickness on the order of 1-3 inches and preferably 2 inches, it is preferred that the stems 26 of the flowers 24 be of a length less than the thickness of the shell 14, such that the cut end is retained within that shell.

With the flowers 24 inserted into the shell 14 as described, the flower heads 28 extend above the outer surface of the shell 14 and, with the flowers tightly and closely populating the entirety of the outer surface, the floral foam sphere 10 takes on the appearance of a flowered sphere.

It is most desired that foam of the solid core 12 be of a lesser density than the foam of the outer spherical shell 14, thus causing the resulting flower foam sphere 10 to be of lesser overall weight than a corresponding foam sphere of a homogeneous material.

It will be appreciated by those skilled in the art that embodiments of the invention may comprise various materials and configurations. While a spherical embodiment has been presented by way of example, other geometric configurations of a floral base having a core of a first material covered, fully or partially, by a shell of a second material for the reasons stated herein are contemplated by the invention.

In use, the sphere 10, absent any flower or vegetation population, is submerged in water until the wettable foam shell 14 is fully saturated. With the core 12 being of a hydrophobic nature, the water does not penetrate the core 12 but is simply retained in the outer shell. Again, this results in a significant reduction of the overall weight of the floral foam shell 10 when in use. With the outer shell 14 being fully hydrated, flowers and other vegetation, with stems cut to a length less than the width or depth of the hydrophilic foam spherical shell 14 are pierced into the shell 14 in standard fashion. When fully populated, the sphere 10 is either suspended as by securement at the hook or ring 20, or simply supported upon a flat surface such as a table, preferably in engagement with the head or washer 18.

Thus it can be seen that the various aspects of the invention have been attained by the structures and techniques presented and described above. While in accordance with the patent statutes only the best mode and preferred embodiments of the invention have been presented and described in detail, the invention is not limited thereto or thereby. Accordingly, for an appreciation of the true scope and breadth of the invention reference should be made to the following claims.

1. A composite floral base for receiving and maintaining fresh cut vegetation in a floral arrangement, comprising:
a core of a first hydrophobic material; and
a shell of a hydrophilic material bonded directly to and substantially entirely covering said core, said shell being provided for receiving and maintaining the ends of fresh cut vegetation in a floral arrangement.

2. The composite floral base for receiving and maintaining fresh cut vegetation in a floral arrangement according to claim 1, wherein said first hydrophobic material comprises a first foam.

3. The composite floral base for receiving and maintaining fresh cut vegetation in a floral arrangement according to claim 2, wherein said first foam comprises a urethane foam.

4. The composite floral base for receiving and maintaining fresh cut vegetation in a floral arrangement according to claim 2, wherein said hydrophilic material comprises a second foam.

5. The composite floral base for receiving and maintaining fresh cut vegetation in a floral arrangement according to claim 4, wherein said second foam comprises a phenolic foam.

6. The composite floral base for receiving and maintaining fresh cut vegetation in a floral arrangement according to claim 5, wherein said shell of phenolic foam has a thickness on the order of 1-3 inches.

7. The composite floral base for receiving and maintaining fresh cut vegetation in a floral arrangement according to claim 6, wherein said thickness is uniform.

8. The composite floral base for receiving and maintaining fresh cut vegetation in a floral arrangement according to claim 5, wherein said phenolic foam shell is bonded to said core of said first foam.

9. A composite floral sphere for receiving and maintaining fresh cut vegetation in a floral arrangement, comprising:
a core of a hydrophobic foam; and
a shell of a hydrophilic foam bonded to and substantially entirely encasing said core in contacting engagement.

10. The composite floral sphere for receiving and maintaining fresh cut vegetation in a floral arrangement according to claim 9, further comprising a hanging rod extending through said shell and core.

11. The composite floral sphere for receiving and maintaining fresh cut vegetation in a floral arrangement according to claim 10, wherein said hanging rod extends diametrically through said shell and core.

12. The composite floral sphere for receiving and maintaining fresh cut vegetation in a floral arrangement according to claim 10, wherein said hydrophilic foam comprises a urethane foam.

13. The composite floral sphere for receiving and maintaining fresh cut vegetation in a floral arrangement according to claim 12, wherein said hydrophilic foam comprises phenolic foam.

14. The composite floral sphere for receiving and maintaining fresh cut vegetation in a floral arrangement according to claim 13, wherein said shell has a uniform wall thickness on the order of 1-3 inches.

15. A spherical floral arrangement, comprising:
an inner core of hydrophobic foam;
an outer shell of hydrophilic foam bonded to and substantially entirely encasing said inner core; and
a plurality of flowers having cut stems, ends of said cut stems being received and maintained by said outer shell, heads of said flowers extending about an outer surface of said shell.

16. The spherical floral arrangement according to claim 15, wherein said hydrophilic foam comprises a phenolic foam.

17. The spherical floral arrangement according to claim 16, wherein said hydrophilic foam comprises a urethane foam.

18. The spherical floral arrangement according to claim 17, wherein cut stems have an end fully received by said outer shell.

19. The spherical floral arrangement according to claim 18, further comprising a support rod extending diametrically through said outer shell and inner core.
